(19) United States
(12) Patent Application Publication
(10) Pub. No.: US 2018/0312729 A1
(43) Pub. Date: Nov. 1, 2018

(54) RELEASE AGENT COMPOSITION, RELEASE SHEET, AND ADHESIVE BODY

(71) Applicant: LINTEC CORPORATION, Itabashi-ku (JP)

(72) Inventors: Chiharu HIRANO, Saitama-shi (JP); Sou MIYATA, Shiraoka-shi (JP); Ryo TAKAHASHI, Koshigaya-shi (JP); Koji MIYAMOTO, Tsukuba-shi (JP)

(73) Assignee: LINTEC CORPORATION, Itabashi-ku (JP)

(21) Appl. No.: 15/772,669

(22) PCT Filed: Nov. 1, 2016
(86) PCT No.: PCT/JP2016/082487

§ 371 Date: May 1, 2018

(30) Foreign Application Priority Data
Nov. 6, 2015 (JP) 2015-218288

(51) Int. Cl. C09J 7/40; C09D 109/00

(52) U.S. Cl. CPC C09J 7/401; C09J 2433/005; C09J 2409/005; C09D 109/00

(57) ABSTRACT

The release agent composition of the invention contains a rubber elastomer (A) and an acrylic polymer (B) containing a structural unit derived from a long-chain alkyl (meth)acrylate (b1) represented by the following formula (1):

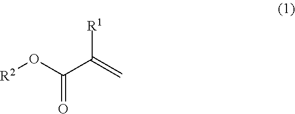

wherein R¹ represents a hydrogen atom or a methyl group, and R² represents a branched alkyl group having 10 to 30 carbon atoms.

### TECHNICAL FIELD

The present invention relates to a release agent composition, and to a release sheet and a pressure sensitive adhesive body using the release agent composition, and especially to a release agent composition, a release sheet and a pressure sensitive adhesive body for use for electronic parts, etc.

### BACKGROUND ART

Electronic parts such as relays, various switches, connectors, motors, hard discs and others are widely used in various products. Pressure sensitive adhesive sheets may be stuck to these electronic parts for the purpose of temporary joint and content indication for the parts in assembling, etc. In general, a pressure sensitive adhesive sheet includes a pressure sensitive adhesive sheet substrate and a pressure sensitive adhesive layer formed on the substrate, and before it is stuck to an adherend such as an electronic part or the like, in general, a release sheet is adhered to the pressure sensitive adhesive layer to protect the adhesive layer.

A release agent layer is provided on the surface of the release sheet (that is, the contact face to the pressure sensitive adhesive layer) for improving the releasability in peeling the release sheet from the pressure sensitive adhesive layer. As the constituent material for the release agent layer, a silicone resin is generally used.

However, in a release sheet using a silicone resin, a silicone compound in the release agent layer may transfer to electronic parts to have some negative influence on the electronic parts. Heretofore, for solving the problem of such silicone contamination, development of a so-called non-silicone release agent not containing the silicone compound is under way.

For example, PTLs 1 and 2 disclose non-silicone release agent compositions containing an acrylic polymer having a structural unit derived from a long-chain alkyl (meth)acrylate, a liquid polymer such as polybutadiene or the like or a polyester resin, and a crosslinking agent. In these release agent compositions, a long-chain alkyl (meth)acrylate having a linear long-chain alkyl group, such as lauryl acrylate, myristyl acrylate, stearyl acrylate or the like is used as the long-chain alkyl (meth)acrylate. The release agent compositions described in PTLs 1 and 2 use such a specific long-chain alkyl (meth)acrylate to realize peeling performance in some degree.

### CITATION LIST

### Patent Literature

PTL 1: Japanese Patent 5000126

### PTL 2: WO2012/020673

### SUMMARY OF INVENTION

### Technical Problem

When a release sheet is rolled up after production, the back surface of the release sheet is kept in contact with the release agent layer and the release agent in the release agent layer may transfer to the back surface of the release sheet. With that, for example, when a pressure sensitive adhesive sheet protected by the release sheet is rolled up, the release agent having transferred to the back surface of the release sheet may further transfer to the surface of the substrate of the pressure sensitive adhesive sheet. In the case where the release agent transfers to the substrate surface of the pressure sensitive adhesive sheet, the printability on the pressure sensitive adhesive sheet may worsen therefore causing a trouble in use of the sheet for content indication. Further, when a pressure sensitive adhesive sheet is produced in a roll-to-roll mode, the release agent may transfer and accumulate on guide rolls, therefore causing other troubles of pressure sensitive adhesive sheet conveyance failure, secondary transfer to other products, etc.

However, the non-silicone release agent compositions disclosed in PTLs 1 and 2 could not sufficiently prevent transfer of the release agent in the release agent layer to the back surface of the release sheet and could not sufficiently improve the releasability of the release agent layer.

Then the present invention has been made in consideration of the above-mentioned situation, and its object is to provide a release agent composition capable of realizing easy releasability while preventing the release agent components from transferring to the other member kept in contact with the release agent, such as the back surface of the release sheet, etc.

### Solution to Problem

As a result of assiduous studies, the present inventors have found that a release agent composition containing a rubber elastomer and an acrylic polymer having a structural unit derived from a branched long-chain alkyl (meth)acrylate (a1) can solve the above-mentioned problem. The present invention provides the following release agent composition, release sheet and pressure sensitive adhesive body.

[1] A release agent composition containing a rubber elastomer (A) and an acrylic polymer (B) containing a structural unit derived from a long-chain alkyl (meth)acrylate (b1) represented by the following formula (1):

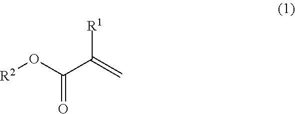

wherein R¹ represents a hydrogen atom or a methyl group, and R² represents a branched alkyl group having 10 to 30 carbon atoms.
[2] The release agent composition according to the above [1], wherein the long-chain alkyl (meth)acrylate (b1) is represented by the following formula (2):

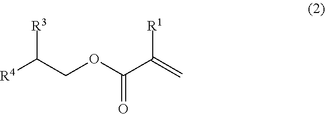

wherein R¹ is the same as above, and R³ and R⁴ each independently represent a linear or branched alkyl group having 2 to 20 carbon atoms.
[3] The release agent composition according to the above [2], wherein R³ and R⁴ in the formula (2) each are a linear alkyl group.
[4] The release agent composition according to any one of the above [1] to [3], wherein the acrylic polymer (B) contains the structural unit derived from a long-chain alkyl (meth)acrylate (b1) in a ratio of 80% by mass or more.
[5] The release agent composition according to any one of the above [1] to [4], wherein the acrylic polymer (B) further contains a structural unit derived from a functional group-containing monomer (b2) containing at least one functional group selected from the group consisting of a hydroxy group, a carboxy group and an amino group.
[6] The release agent composition according to any one of the above [1] to [5], wherein the mass-average molecular weight of the acrylic polymer (B) is from 50,000 to 500,000.
[7] The release agent composition according to any one of the above [1] to [6], wherein the rubber elastomer (A) is at least one selected from the group consisting of a polybutadiene, a polyisoprene, a styrene-butadiene copolymer, a styrene-isoprene copolymer, an acrylonitrile-butadiene copolymer, a polychloroprene, and hydrogenates thereof, an olefinic copolymer, and a polyisobutylene.
[8] The release agent composition according to any one of the above [1] to [7], wherein the rubber elastomer (A) has at least one functional group selected from the group consisting of a hydroxy group, a carboxy group, an amino group, an isocyanate group and a (meth)acryloyl group.
[9] The release agent composition according to any one of the above [1] to [8], wherein the number-average molecular weight of the rubber elastomer (A) is from 500 to 30,000.
[10] The release agent composition according to any one of the above [1] to [9], wherein the ratio by mass of the content of the rubber elastomer (A) to the content of the acrylic polymer (B) is within a range of (A)/(B)=1/99 to 99/1.
[11] The release agent composition according to any one of the above [1] to [10], further containing a crosslinking agent (C).
[12] A release sheet including a substrate, and, as provided on at least one face of the substrate, a release agent layer formed of a cured product of the release agent composition of any one of the above [1] to [11].
[13] The release sheet according to the above [12], wherein the thickness of the release agent layer is from 50 to 1,000 nm.
[14] The release sheet according to the above [12] or [13], wherein the surface free energy of the release agent layer, as measured according to a contact angle method, is 30 mJ/m² or less. [15] A pressure sensitive adhesive body including the release sheet of any one of the above [12] to [14], and a pressure sensitive adhesive layer provided on the release agent layer of the release sheet.

### Advantageous Effects of Invention

According to the present invention, there can be provided a release agent composition that can realize easy releasability while preventing the release agent components from transferring to the other member kept in contact with the release agent.

### DESCRIPTION OF EMBODIMENTS

Embodiments of the present invention are described in detail hereinunder.

In the following description, “mass-average molecular weight (Mw)” and “number-average molecular weight (Mn)” are polystyrene-equivalent values measured according to a gel permeation chromatography (GPC) method, and specifically values measured according to the method described in the section of Examples.

In this description, for example, “(meth)acrylate” is used as a term indicating both “acrylate” and “methacrylate”, and the same shall apply to the other similarity terms.

### <Release Agent Composition>

The release agent composition of the present invention contains a rubber elastomer (A) and an acrylic polymer (B). The release agent composition may be used as a cured release agent, but is generally used as a thin-film release agent layer provided on a substrate. These components (A) and (B) are described in detail hereinunder.

### [Rubber Elastomer (A)]

The rubber elastomer (A) to be used in the release agent composition of the present invention includes a polybutadiene, a polyisoprene, a styrene-butadiene copolymer, a styrene-isoprene copolymer, an acrylonitrile-butadiene copolymer, a polychloroprene, and hydrogenates thereof, an olefinic copolymer, a polyisobutylene, etc. Containing the rubber elastomer (A), the release agent composition can be highly adhesive to substrates and can form a suitable film.

Among those mentioned above, the rubber elastomer (A) is preferably at least one selected from a polybutadiene, a polyisoprene, a styrene-butadiene copolymer, a styrene-isoprene copolymer, and hydrogenates thereof, and an olefinic copolymer.

At least one selected from a polybutadiene, a polyisoprene and hydrogenates thereof is more preferred as being able to form a cured product having a low modulus of elasticity, at least one selected from a polyisoprene hydrogenate and a polybutadiene is more preferred, and a polybutadiene is even more preferred.

The polybutadiene can be a linear polymer through 1,4-addition polymerization of butadiene, and can be a branched chain-having polymer through 1,2-addition polymerization of butadiene. The polybutadiene may be a linear polymer or may have a few branched chains. Specifically, the polybutadiene may include units formed through 1,4-addition polymerization of butadiene, or may include units formed through 1,4-addition polymerization of butadiene and units formed through 1,2-addition polymerization of butadiene.

The polybutadiene for use in the present invention preferably such that the proportion of the units formed through 1,4-addition polymerization of butadiene is 50% or more of all the structural units, more preferably 70% or more, and even more preferably 80% or more.

The styrene-butadiene copolymer and the styrene-isoprene copolymer each are a copolymer of styrene, and butadiene or isoprene, and may be a random copolymer or a block copolymer. The block copolymer is not limited to a diblock form of styrene-butadiene (or -isoprene) and may include those containing three or more blocks such as a tri-block form or the like as exemplified by a styrene-butadiene-styrene block copolymer.

The olefinic copolymer is formed by copolymerization of at least two kinds of olefins to have a rubber-like property, and specifically includes an ethylene-α-olefin copolymer. The a-olefin is preferably an α-olefin having 3 to 10 carbon atoms such as propylene, 1-butene, 4-methyl-1-pentene, 1-hexene, 1-octene, etc., and above all, propylene is preferred. One alone or two or more kinds of these α-olefins may be used either singly or as combined.

The olefinic copolymer may contain a recurring unit of any other monomer than olefins, and the monomer includes a non-conjugated diene compound such as ethylidene-norbornene, 1,4-hexadiene, dicyclopentadiene, etc.

Specific examples of the olefinic copolymer include ethylene-propylene rubber (EPM), ethylene-propylene-diene rubber (EPDM), etc.

Preferably, the rubber elastomer (A) has a functional group. Having a functional group, the rubber elastomer (A) can be readily crosslinked so that the release agent composition can be readily cured. The functional group includes a hydroxy group, a carboxy group, an amino group, an isocyanate group, and a (meth)acryloyl group. One alone or two or more kinds of these functional groups may be used either singly or as combined.

Preferably, the functional group is at least one functional group selected from a hydroxy group, a carboxy group, an amino group and an isocyanate group, more preferably at least one functional group selected from a hydroxy group, a carboxy group and an amino group, even more preferably at least one functional group selected from a hydroxy group and a carboxy group, and most preferably a hydroxy group.

More preferably, the rubber elastomer (A) has a functional group at the terminal, and even more preferably has a functional group at both terminals. Accordingly, the rubber elastomer (A) is even more preferably at least one selected from a polybutadiene, a polyisoprene and hydrogenates thereof having a hydroxy group at both terminals, still more preferably at least one selected from a polyisoprene hydrogenate and a polybutadiene having a hydroxy group at both terminals, and especially preferably a polybutadiene having a hydroxy group at both terminals.

The number-average molecular weight (Mn) of the rubber elastomer (A) is preferably 500 to 30,000. Since the rubber elastomer has such a relatively low molecular weight, the acrylic polymer (B) can be eccentrically located with ease in the surface of the release agent layer to realize with ease the easy releasability of the release agent layer, as described below.

The number-average molecular weight of the rubber elastomer (A) is more preferably 800 to 20,000, even more preferably 1,000 to 12,000.

Also preferably, the rubber elastomer (A) is a liquid polymer that can be liquid at room temperature (23° C.). When the component (A) is a liquid polymer, the rubber elastomer (A) can have a low glass transition temperature and the peel force thereof can be lightened. In addition, containing such a liquid polymer, the composition can be excellent in handleability.

One alone or two or more kinds of the above-mentioned rubber elastomers (A) can be used either singly or as combined.

### [Acrylic Polymer (B)]

The acrylic polymer (B) for use in the present invention contains a structural unit derived from a long-chain alkyl (meth)acrylate (b1) represented by the following formula (1):

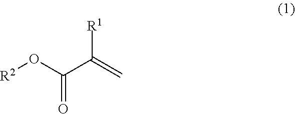

wherein R¹ represents a hydrogen atom or a methyl group, and R² represents a branched alkyl group having 10 to 30 carbon atoms.

In the release agent layer to be formed by curing the release agent composition containing the above-mentioned rubber elastomer (A) and acrylic polymer (B), the acrylic polymer (B) can be eccentrically located with ease in the surface of the release agent layer (for example, in the surface opposite to the side of the substrate of the release agent layer). As a result, the carbon chain density in the surface of the release agent layer increases to readily enhance peeling performance. In addition, since the rubber elastomer (A) can be eccentrically located with ease relatively in a large amount on the substrate side, the adhesiveness to substrate can be readily enhanced. Since the component (b1) is used, the side chains of the acrylic polymer (B) can be branched to prevent crystallization though the carbon chain of the side chain is large, therefore realizing easy releasability.

Further, in the present invention, the rubber elastomer (A) having a low modulus of elasticity and the acrylic polymer (B) having a branched alkyl group with 10 to 30 carbon atoms in the side chain are used together, the release agent components can be prevented from transferring to any other member. Accordingly, for example, when the release sheet is rolled up, the release agent components can be prevented from transferring to the back surface of the release sheet.

On the other hand, when the carbon number of R² in the formula (1) is less than 10, the carbon chain density in the surface of the release agent layer lowers and, if so, the composition could hardly express peeling performance and could not prevent the release agent components from transferring to other members. When the carbon number of R² is more than 30, the monomers would be hardly available, and the composition could hardly prevent crystallization therefore often causing difficulty in peeling. Further, the solubility of the acrylic polymer in an organic solvent may lower, and the processability of the release agent composition in coating may worsen.

For more improving easy releasability while preventing transfer of release agent components, the carbon number of R² is preferably 14 to 24, more preferably 16 to 24.

More specifically, the long-chain alkyl (meth)acrylate (b1) is preferably a compound represented by the following formula (2):

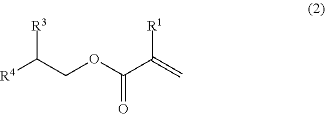

wherein R¹ is the same as above, and R³ and R⁴ each independently represent a linear or branched alkyl group having 2 to 20 carbon atoms.

The component (b1) has two carbon chains (R³, R⁴) each having a relatively large carbon number, as in the formula (2), and can therefore more surely retain easy releasability while preventing transfer of the release agent components.

In the formula (2), preferably, R³ and R⁴ each are a linear alkyl group, or an alkyl group having a nearly linear structure, and above all, more preferably, both the two are linear alkyl groups. The alkyl group having a nearly linear structure is, for example, a structure having one branched methyl group in the linear hydrocarbon chain thereof.

Further, in the compound of the formula (2), preferably, R³ and R⁴ each have a length in some degree, and the carbon number thereof is preferably 3 to 18, more preferably 4 to 16, even more preferably 6 to 12.

For preventing transfer of pressure sensitive adhesive components, preferably, both of R³ and R⁴ have 6 to 12 carbon atoms each, and specifically, 2-decyltetradecanyl (meth)acrylate and 2-hexyldecyl (meth)acrylate are especially preferred.

Further, for realizing excellent easy releasability, both of R³ and R⁴ have 10 to 12 carbon atoms each, and specifically, 2-decyltetradecanyl (meth)acrylate is especially preferred.

Preferably, the acrylic polymer (B) contain the structural unit derived from a long-chain alkyl (meth)acrylate (b1) in a ratio of 80% by mass or more. When the content is 80% by mass or more, easy releasability can be more readily realized while preventing the pressure sensitive adhesive components from transferring to other members. The upper limit of the content of the structural unit derived from the component (b1) is not specifically limited, but in order that the polymer can contain a structural unit derived from a functional group-containing monomer (b2) to be mentioned below, the content in the acrylic polymer (B) is preferably 99.9% by mass or less.

The content of the structural unit derived from the component (b1) is more preferably 92 to 99.5% by mass in the acrylic polymer (B), even more preferably 95 to 99% by mass. Having such a content, the polymer may contain the structural units derived from the components (b1) and (b2) in a well-balanced manner, and therefore can more readily enhance easy releasability while effectively preventing transfer of pressure sensitive adhesive components.

Preferably, the acrylic polymer (B) has a functional group. Having a functional group, the acrylic polymer (B) may be readily crosslinked to readily cure the release agent composition. When the acrylic polymer (B) is crosslinked, the film property and the durability of the release agent improve to readily lighten the peel force. Further, in the present invention, when both the component (A) and the component (B) have a functional group, the release agent can form a high-density crosslinked structure.

The functional group that the acrylic polymer (B) has may be a functional group capable of reacting with a crosslinking agent (C) to be mentioned below. Specific examples of the functional group include a hydroxy group, a carboxy group and an amino group, and among these, a hydroxy group is preferred. One alone or two or more kinds of these functional groups may be used either singly or as combined.

Since the acrylic polymer (B) has a structural unit derived from a functional group-containing monomer (b2), the functional group is introduced into the molecule of the acrylic polymer (B).

The functional group monomer (b2) has, in addition to the functional group, an ethylenic double bound of a (meth)acryloyl group or the like so as to be copolymerized with the component (b1).

Specific examples of the functional monomer (b2) include hydroxy group-containing (meth)acrylates such as hydroxymethyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, etc.; carboxy group-containing (meth)acrylates such as 1,4-di(meth)acryloxyethylpyromellitic acid, 4-(meth)acryloxyethyltrimellitic acid, 2-(meth)acryloyloxybenzoic acid, etc.; ethylenic unsaturated carboxylic acids such as acrylic acid, methacrylic acid, crotonic acid, maleic acid, itaconic acid, citraconic acid, etc.; and amino group-containing (meth)acrylates such as aminoethyl (meth)acrylate, ethylaminoethyl (meth)acrylate, aminopropyl (meth)acrylate, ethylaminopropyl (meth)acrylate, etc.

Among these, hydroxy group-containing (meth)acrylates are preferred, and 2-hydroxyethyl (meth)acrylate is more preferred.

Preferably, the acrylic polymer (B) contains a structural unit derived from the functional monomer (b2) in a ratio of 0.1 to 20% by mass. When the content of the component (b2) is 0.1% by mass or more, the polymer may be appropriately crosslinked with the crosslinking (C) or the like to be mentioned below, therefore readily bettering the filming property of the release agent layer and lightening the peel force thereof. In addition, when the content is 20% by mass or less, an appropriate amount of the component (b1)-derived structural unit can be contained in the acrylic polymer (B). The functional group monomer (b2)-derived structural unit is more preferably contained in the acrylic polymer (B) in a ratio of 0.5 to 8% by mass, even more preferably 1 to 5% by mass.

Preferably, the acrylic polymer (B) is a homopolymer of the component (b1) or a copolymer of the component (b1) and the component (b2), but within a range not overstepping the object of the present invention, the polymer may be further copolymerized with any other monomer component than the components (b1) and (b2). The additional monomer component-derived structural unit may be generally in an amount of 10% by mass or less of the acrylic polymer (B), preferably 5% by mass or less.

Preferably, the mass-average molecular weight (Mw) of the acrylic polymer (B) is 50,000 to 500,000. Having a mass-average molecular weight falling within the range, the acrylic polymer (B) can be eccentrically located with ease in the surface of the release agent layer, therefore readily realizing easy releasability of the release agent layer. More preferably, the mass-average molecular weight of the acrylic polymer (B) is 70,000 to 250,000, even more preferably 100,000 to 200,000.

One alone or two or more kinds of the above-mentioned acrylic polymers (B) may be used either singly or as combined.

In the release agent composition, the ratio by mass of the content of the rubber elastomer (A) to that of the acrylic polymer (B) is preferably within a range of (A)/(B)=1/99 to 99/1. Falling within the range, the release agent composition can attain the effect of containing both the two components, the component (A) and the component (B).

More preferably, the ratio of (A)/(B) is 30/70 to 95/5, even more preferably 50/50 to 90/10. When the ratio by mass is not lower than the lower limit, the component (A) can be contained in an appropriate amount in the release agent composition to readily enhance adhesiveness to substrate, and in addition, prevent blocking when rolled up. When the ratio is not higher than the upper limit, the component (B) can be contained in an appropriate amount in the release agent composition to prevent the peel force from being too heavy beyond necessity.

### [Crosslinking Agent (C)]

The release agent composition of the present invention preferably contains a crosslinking agent (C). Containing a crosslinking agent (C), the release agent composition can readily form a crosslinked structure and therefore can be readily cured. As the crosslinking agent (C), a compound capable of reacting with the functional group that the rubber elastomer (A) and the acrylic polymer (B) have is used.

The crosslinking agent (C) varies depending on the kind of the functional group that the rubber elastomer (A) and the acrylic polymer (B) have, and specific examples thereof include a melamine compound, an isocyanate compound, an epoxy compound, an aziridine compound, a hydrazide compound, an oxazoline compound, a carbodiimide compound, an urea compound, a dialdeyde compound, a metal chelate compound, a metal alkoxide compound, and a metal salt.

In the case where any one or both of the component (A) and the component (B) have a hydroxy group as a functional group, the crosslinking agent (C) is preferably at least one selected from a melamine compound, an isocyanate compound, an epoxy compound, an aziridine compound, a hydrazide compound, an oxazoline compound, a carbodiimide compound, an urea compound, a dialdehyde compound and a metal chelate, more preferably at least one selected from a melamine compound, an isocyanate compound and an epoxy compound, even more preferably at least one selected from a melamine compound and an isocyanate compound, and especially preferably a melamine compound. A melamine compound has a high crosslinking speed and can form a crosslinked structure at a high crosslinking density.

The melamine compound usable as the crosslinking agent (C) includes a methylated melamine resin, an iminomethylolated melamine resin, a methylated melamine resin, an ethylated melamine resin, a propylated melamine resin, a butylated melamine resin, a hexylated melamine resin, an octylated melamine resin, etc., an alkylated melamine resin with an alkyl group having 3 or less carbon atoms is preferred, and a methylated melamine resin is especially preferred.

Examples of the isocyanate compound include diphenylmethane diisocyanate (MDI), tolylene diisocyanate (TDI), pentamethylene diisocyanate (PDI), hexamethylene diisocyanate (HDI), isophorone diisocyanate, (IPDI), trimethylhexamethylene diisocyanate (TMDI), xylene diisocyanate (XDI), naphthalene diisocyanate (NDI), trimethylolpropane adduct TDI, trimethylolpropane adduct HDI, trimethylolpropane adduct IPDI, trimethylolpropane adduct XDI, etc.

The content of the crosslinking agent (C) in the release agent composition is preferably 1 to 30 parts by mass relative to the total content, 100 parts by mass of the rubber elastomer (A) and the acrylic polymer (B) therein, more preferably 2 to 15 parts by mass. When the content of the crosslinking agent (C) falls within the range, the release agent composition can be efficiently cured.

One alone or two or more kinds of the above-mentioned crosslinking agents may be used either singly or as combined.

### [Photoinitiator (D)]

In the case where at least any functional group that the rubber elastomer (A) and the acrylic polymer (B) have in the release agent composition comes to react through irradiation with active energy rays, the composition preferably contains a photoinitiator (D). For example, in the case where the rubber elastomer (A) contains a (meth)acryloyl group as the functional group, the release agent composition preferably contains a photoinitiator (D).

The photoinitiator (D) may be used along with the crosslinking agent (C) depending on the kind of the rubber elastomer (A) and the acrylic polymer (B), or may be used singly.

The photoinitiator (D) includes a benzophenone photoinitiator, an alkylphenone photopolymerization initiator, an acylphosphine oxide photopolymerization initiator, a titanocene photopolymerization initiator, an oxime ester photopolymerization initiator, a thioxanthone photopolymerization initiator, etc. One alone or two or more kinds of of photoinitiators (D) may be used either singly or as combined.

Within a range not detracting from the advantageous effects of the present invention, the release agent composition of the present invention may contain any other component (E) than the above-mentioned components (A) to (D), for example, additives such as an antistatic agent, a surfactant, an antioxidant, a lubricant, a flame retardant, a colorant, a lightproof stabilizer, a heat-resistant stabilizer, etc. In addition, the composition may contain a known acid catalyst such as hydrochloric acid, p-toluenesulfonic acid or the like.

In the case where the release agent composition contains any other component than the above-mentioned components (A) to (C), the content of the other component than the components (A) to (C) is generally 30 parts by mass or less based on the total content, 100 parts by mass of the component (A) and the component (B), preferably 0.1 to 15 parts by mass.

Preferably, the release agent composition of the present invention does not contain a silicone compound, but when containing it, the amount thereof is preferably small so as not to have any negative influence on electronic parts. When the release agent composition is formed into a release agent layer, preferably, the ratio of the Si element in the surface of the release agent layer falls within the range to be mentioned below.

### <Release Sheet>

The release sheet of the present invention includes a substrate, and, as provided on at least one face of the substrate, a release agent layer formed of a cured product of the above-mentioned release agent composition. In the release sheet, the release agent layer may be provided on one face only of the substrate, or may be provided on both faces thereof. In the case where the release agent layer is provided on both faces, both the two release agent layers may be cured products of the above-mentioned release agent composition, but one release agent layer may be formed of the cured product of the release agent composition while the other release agent layer may be formed of any other release agent than the above-mentioned release agent composition.

The release agent layer may be formed directly on the surface of the substrate, or may be formed thereon via any other layer such as a primer layer, etc.

In the following description, the release agent layer formed of the cured product of the above-mentioned release agent composition may be referred to as “the release agent layer of the present invention”, and the release sheet having the release agent layer may be referred to as “the release sheet of the present invention”.

### [Substrate]

The substrate of the release sheet of the present invention includes a resin film of a resin, for example, a polyester such as polyethylene terephthalate (PET), polyethylene naphthalate, polybutylene terephthalate, etc., a polyolefin such as polypropylene, polymethylpentene, etc., or a polycarbonate, a polyimide, a polyether imide, a polyether ketone, a polyether ether ketone, a polymethyl methacrylate, a triacetyl cellulose, a polynorbornene, etc.; a metal foil of a metal such as aluminum, stainless, etc.; a paper substrate such as glassine paper, wood-free paper, coated paper, impregnated paper, synthetic paper, laminate paper formed by laminating a thermoplastic resin such as polyethylene or the like on such paper substrate, etc.; and a fabric substrate such as non-wovens, etc. Among these, a resin film is preferred, and a polyester film of polyethylene terephthalate or the like is especially preferred from the viewpoint of heat resistance, strength, adhesiveness to release agent layer, etc.

The thickness of the substrate in the release sheet varies for many purposes and depending on the kind of the substrate, but is preferably 5 to 300 μm, more preferably 10 to 200μm.

### [Release Agent Layer]

The release agent layer in the present invention is formed of the above-mentioned release agent composition and therefore the carbon density in the surface of the release agent layer is high and the surface free energy thereof is low. Specifically, the surface free energy of the surface of the release agent layer in the present invention is preferably 30 mJ/m² or less. When the surface free energy is 30 mJ/m² or less, the wettability of the pressure sensitive adhesive layer and others arranged on the release agent layer is suppressed to prevent the release agent layer from being difficult to peel.

The surface free energy is calculated according to the Kitasaki-Hata method where the contact angle to three liquids of water, diiodomethane and 1-bromonaphthalane are measured at 23° C. and 50% RH.

The release agent layer in the present invention is, as mentioned above, formed of the release agent composition containing the components (A) and (B) as the main ingredients, in which, therefore, the content of a silicone compound is small or which does not contain a silicone compound.

Preferably, the ratio of the Si element in the surface of the release agent layer is less than 0.5 atm %, more preferably less than 0.1 atm %. Since the ratio of the Si element is defined to be so low, a silicone compound does not transfer to electronic parts when the release sheet is applied to electronic parts, and therefore electronic parts can be protected from receiving any negative influence of a silicone compound.

The ratio of the Si element can be measured through XPS surface elemental analysis.

The thickness of the release agent layer in the present invention is preferably 50 to 1,000 nm, more preferably 70 to 500 nm, even more preferably 100 to 300 nm. When the thickness of the release agent layer is not lower than the lower limit, sufficient releasability can be attained in peeling the pressure sensitive adhesive sheet and the like from the release sheet. When the thickness of the release agent layer is not higher than the upper limit, the release agent layer can be protected from blocking to the back surface of the release sheet when the release sheet is rolled up, and therefore degradation of peeling performance by blocking can be prevented.

A polyethylene terephthalate (PET) film and the release agent layer in the present invention are kept in contact with each other and left at room temperature under a pressure of 10 kg/cm² for 24 hours, and after that, the occupancy of the release agent components in the face kept in contact with the release agent layer of the PET film is preferably 55% or less, more preferably 30% or less. The occupancy of the release agent components is a value to be a criterion of the release agent transfer amount, and a smaller value means that the release agent components are prevented more from transferring.

The release agent components occupancy is calculated through XPS surface elemental analysis according to the method described in the section of Examples to be given below.

The release agent layer in the present invention is formed on a substrate, for example, by applying the release agent composition onto a substrate and then curing the coating film thereon. Here, the release agent layer may be cured by heating, or in the case where the functional group that the component (A) or the component (B) have is reactive with active energy rays, the layer may be cured through irradiation with active energy rays, or heating and irradiation with active energy rays may be combined. The active energy rays include UV rays, electron beams, etc.

Preferably, the release agent composition is diluted with an organic solvent or the like and the resultant diluted solution of the release agent composition is applied onto a substrate. The organic solvent to be used for diluting the release agent composition is not specifically limited, and examples thereof include toluene, xylene, methanol, ethanol, isobutanol, n-butanol, ethyl acetate, methyl ethyl ketone, acetone, tetrahydrofuran, isopropanol, dimethylformamide, N-methylpyrrolidone, etc. In the case where the release agent composition is diluted with an organic solvent and applied to a substrate, preferably the coating film is dried by heating. The release agent composition may be cured by the heat in drying, or may be cured by any other means than the heat in drying.

Coating with the release agent composition may be carried out, for example, according to a spin coating method, a spray coating method, a bar coating method, a knife coating method, a roll coating method, a roll knife coating method, a blade coating method, a die coating method, a gravure coating method, etc.

### <Pressure Sensitive Adhesive Body>

The pressure sensitive adhesive body of the present invention includes the above-mentioned release sheet of the present invention, and a pressure sensitive adhesive layer provided on the release agent layer of the release sheet. The pressure sensitive adhesive layer in the pressure sensitive adhesive layer is so arranged as to be kept in contact with the release agent layer. The pressure sensitive adhesive body is used in such that the release sheet is peeled from the pressure sensitive adhesive layer, and the pressure sensitive adhesive layer is adhered to an adherend.

The pressure sensitive adhesive layer is preferably composed of a non-silicone pressure sensitive adhesive such as an acrylic adhesive, a polyester adhesive, an urethane adhesive or the like, and among these, an acrylic adhesive is more preferred.

The pressure sensitive adhesive layer formed of a non-silicone pressure sensitive adhesive does not contain a silicone compound, but even when containing the compound, the content thereof in the layer is small. Specifically, in the pressure sensitive adhesive layer, the amount of a silicone compound is preferably 500 μg/m² or less, more preferably 100 μg/m² or less.

In the present invention, a non-silicone pressure sensitive adhesive is used, and in addition, the release agent layer is a formed of a non-silicone release agent to prevent a silicone compound from adhering to electronic parts.

The thickness of the pressure sensitive adhesive layer varies, depending on the use thereof, and is generally 2 to 250 μm, preferably 10 to 100 μm.

In the pressure sensitive adhesive body, the release sheet of the present invention has a low peel force to the pressure sensitive adhesive layer, and specifically, the peel force is preferably 180 mN/20 mm or less, more preferably 150 mN/20 mm or less.

The lower limit of the peel force is not specifically limited, but for preventing the release sheet from unexpectedly peeling from the pressure sensitive adhesive layer to thereby enhance the protection performance, the peel force is preferably 30 mN/20 mm or more, more preferably 50 mN/20 mm or more.

The peel force of the release sheet of the present invention is measured according to JIS Z0237, at a peel angle of 180° and a peel rate of 0.3 m/min.

### [Pressure Sensitive Adhesive Sheet]

Though not specifically limited, the pressure sensitive adhesive body includes a pressure sensitive adhesive sheet including a pressure sensitive adhesive sheet substrate and a pressure sensitive adhesive layer as provided on at least one face of the pressure sensitive adhesive sheet substrate, in which a release sheet of the present invention is stuck to the pressure sensitive adhesive layer.

The pressure sensitive adhesive sheet is a one-side pressure sensitive adhesive sheet with a pressure sensitive adhesive layer provided on one face alone of a pressure sensitive adhesive sheet substrate. The pressure sensitive adhesive sheet is used in such that the release sheet is peeled from the pressure sensitive adhesive layer, and then the laminate of the pressure sensitive adhesive layer and the pressure sensitive adhesive sheet substrate is stuck to an adhered via the pressure sensitive adhesive layer.

The pressure sensitive adhesive sheet substrate includes a resin film, a metal foil, a paper substrate, a fabric substrate, etc. The materials of these resin films and others are not specifically limited, for which any one may be adequately selected from those listed for the substrate of the release sheet mentioned hereinabove.

The thickness of the pressure sensitive adhesive sheet substrate is not specifically limited, and is generally within a range of 5 to 500 μm, but from the viewpoint of easy handleability, the thickness is preferably 10 to 300 μm.

The pressure sensitive adhesive layer may be directly formed on the surface of the pressure sensitive adhesive sheet substrate, or may be formed thereon via any other layer such as a primer layer, etc.

### (Method for Producing Pressure Sensitive Adhesive Sheet)

A method for producing the pressure sensitive adhesive sheet is not specifically limited. For example, an organic solvent is added to a pressure sensitive adhesive composition to prepare a solution of the pressure sensitive adhesive composition. Then, according to a known method, the solution of the pressure sensitive adhesive composition is applied onto the face of a release sheet having thereon a release agent layer formed to form a coating film, then the coating film is heated and dried to form a pressure sensitive adhesive layer, and the resultant pressure sensitive adhesive layer is stuck to a pressure sensitive adhesive sheet substrate to produce the pressure sensitive adhesive sheet.

Alternatively, a solution of a pressure sensitive adhesive composition may be directly applied on one face of a pressure sensitive adhesive sheet substrate, then heated and dried to form a pressure sensitive adhesive layer, and thereafter a release sheet may further stuck to the pressure sensitive adhesive layer to produce the pressure sensitive adhesive sheet.

The organic solvent to be used here is not specifically limited, for which the organic solvents listed hereinabove as a diluent are usable.

### [Double-Sided Pressure Sensitive Adhesive Sheet]

The pressure sensitive adhesive body may be a double-sided pressure sensitive adhesive sheet. The double-sided pressure sensitive adhesive sheet includes a pressure sensitive adhesive sheet substrate to be a core material of the double-sided pressure sensitive adhesive sheet and a pressure sensitive adhesive layer provided on both sides of the pressure sensitive adhesive sheet substrate. Also in the double-sided pressure sensitive adhesive sheet, the release sheet of the present invention is stuck to any one or both of the pressure sensitive adhesive layers, but is preferably stuck to both of the layers.

As the core material (pressure sensitive adhesive sheet substrate) and the pressure sensitive adhesive layer in the double-sided pressure sensitive adhesive sheet, the same ones as the pressure sensitive adhesive sheet substrate and the pressure sensitive adhesive layer for use in the pressure sensitive adhesive sheet mentioned above are usable.

A method for producing the double-sided pressure sensitive adhesive sheet is not specifically limited. For example, a pressure sensitive adhesive layer is formed on each face having, as formed thereon, a release agent layer of two release sheets, and these pressure sensitive adhesive layers are stuck to both faces of a pressure sensitive adhesive sheet substrate (core material) to produce the double-sided pressure sensitive adhesive sheet. The method for forming a pressure sensitive adhesive layer on a release sheet is as mentioned above.

### [Substrateless Double-Sided Pressure Sensitive Adhesive Sheet]

The pressure sensitive adhesive body may be a substrateless double-sided pressure sensitive adhesive sheet. The substrateless double-sided pressure sensitive adhesive sheet is a coreless double-sided pressure sensitive adhesive sheet, in which release sheets are stuck to both faces of the pressure sensitive adhesive layer. Regarding the release sheets stuck to both faces, any one of the sheets may be the release sheet of the present invention, but both of the two may be the release sheet of the present invention.

However, preferably, the peel force of the release sheet is so controlled that the peel force to the pressure sensitive adhesive layer of one release sheet differs from the peel force to the pressure sensitive adhesive layer of the other release sheet.

The substrateless double-sided pressure sensitive adhesive sheet is, before use, both release sheets are peeled from the pressure sensitive adhesive layer, and via the pressure sensitive adhesive layer alone, two adherends are adhered.

A method for producing the substrateless double-sided pressure sensitive adhesive sheet is not specifically limited. For example, a pressure sensitive adhesive layer is formed on the surface of the release agent layer of any one release sheet of two release sheets, and the remaining release sheet is stuck to the pressure sensitive adhesive layer to produce the substrateless double-sided pressure sensitive adhesive sheet. Any known method is employable for forming the pressure sensitive adhesive layer on the release sheet.

In the present invention, as mentioned above, the release agent is prevented from transferring to the back surface of the release sheet. Accordingly, release agent components can be prevented from transferring to the surface of the pressure sensitive adhesive sheet via the back surface of the release sheet, and therefore the printability of the surface of the pressure sensitive adhesive sheet is bettered.

Further, in producing various pressure sensitive adhesive bodies such as pressure sensitive adhesive sheets and others in a roll-to-roll production mode, the release agent can be prevented from transferring and accumulating on guide rolls, therefore preventing other troubles of pressure sensitive adhesive body conveyance failure, secondary transfer to other products, etc.

Though not specifically limited thereto, the release agent composition, the release sheet and the pressure sensitive adhesive body of the present invention are usable in various electronic parts, for example, relays, various switches, connectors, motors, hard discs, electronic circuits, mounting pads, etc.

For example, in a production process for these electronic parts, the release agent composition and others of the present invention can be favorably used as a release sheet for the pressure sensitive adhesive sheet for temporal tacking parts, content indications and the like in assembling electronic parts. In addition, the release agent composition and others of the present invention can also be favorably used as a release sheet for a pressure sensitive adhesive body for forming a part of electronic circuits, mounting pads, etc.

In the present invention, the components (A) and (B) that are the main ingredients of the release agent composition are non-silicone compounds, and therefore the release agent composition can be a non-silicone composition. Consequently, silicone compounds can be prevented from transferring to electronic parts, therefore preventing failures to be caused by silicone compounds from occurring in electronic parts.

### EXAMPLES

The present invention will be described in more detail with reference to Examples hereinunder, but the present invention is not restricted by these Examples.

Concrete methods for measurement and evaluation in the present invention are mentioned below.

### [Mass-Average Molecular Weight (Mw) and Number-Average Molecular Weight (Mn)]

The mass-average molecular weight (Mw) and the number-average molecular weight (Mn) were measured under the following conditions using a gel permeation chromatograph apparatus (manufactured by Tosoh Corporation, product name HLC-8020), and the values measured in terms of standard polystyrene were used.

### (Measurement Conditions)

Columns: “TSK guard column HXL-H,” “TSK gel GMHXL (x2),” and “TSK gel G2000HXL” (all manufactured by Tosoh Corporation) were connected in series.
Column temperature: 40° C.
Developing solvent: tetrahydrofuran
Flow velocity: 1.0 mL/min

### [XPS Surface Elementary Analysis]

For surface XPS measurement, PHI Quantera SXM (by Ulvac-Phi, Inc.) was used. As the X-ray source, one-colored Al Kα was used, and the measurement was carried out at a photoelectron take-out angle of 45°, and the electron ratio of electrons (silicon (Si), oxygen (O) and carbon (C)) existing in the surface was calculated.

### [Surface Free Energy]

The contact angle to three liquids of water, diiodomethane and 1-bromonaphthalene was measured at 23° C. and 50% RH, and the surface free energy was calculated according to the Kitasaki/Hata method. For measurement of the contact angle, a contact angle meter “DM-701” (manufactured by Kyowa Interface Science Co., Ltd.) was used.

### [Occupancy Rate of Release Agent Components]

A PET film (product name “Diafoil T100”, manufactured by Mitsubishi Plastics, Inc., thickness: 50 μm) and a release sheet were laminated in such that the surface of the side of the release agent layer of the release sheet could be kept in contact with the PET film, and the laminate was kept at room temperature under a pressure of 10 kg/cm² for 24 hours. Subsequently, the surface of the PET film kept in contact with the release agent layer of the release sheet was subjected to XPS surface elemental analysis to measure the carbon amount Cₜₒₜₐₗ [atm %] therein.

Before the PET film and the release sheet were laminated, the surface of the PET film to be kept in contact with the release sheet and the surface on the release agent layer side of the release sheet were also subjected to XPS surface elemental analysis to measure the carbon amount Cₐ [atm %] in the PET film and the carbon amount C_{b} [atm %] in the release agent layer face.

When the occupancy rate of the release agent components in the face kept in contact with the release agent layer of the PET film is represented by A [%], Cₜₒₜₐₗ={A×C_{b}+(100−A)×Cₐ}/100. From the formula, the release agent components occupancy rate “A” to be a criterion for the release agent transfer amount was calculated.

### [Measurement of Peel Force]

First, a pressure sensitive adhesive sheet was aged in an environment of 23° C. and 50% RH for 1 week. Subsequently, the pressure sensitive adhesive sheet was cut into a size of 20 mm in width and 200 mm in length, and according to JIS Z0237, the release sheet was peeled from the pressure sensitive adhesive layer at a peel angle of 180° and at a peel rate of 0.3 m/min, using a tensile tester “Tension” (manufactured by Orientec Co., Ltd.) to measure the peel force of the sample.

### Example 1

### (Production of Release Sheet)

100 parts by mass (solids content: 70 parts by mass) of a toluene solution (solids concentration: 35% by mass) of a hydroxy group both-terminated liquid polybutadiene (product name “POLY BD R-45HT”, manufactured by Idemitsu Kosan Co., Ltd., number-average molecular weight (Mn): 4,400, hydroxyl value: 46.6 mgKOH/g, 1,4-addition unit polymerization ratio 80.8%) as the rubber elastomer (A), 50 parts by mass (solids content: 30 parts by mass) of a toluene solution (solids concentration: 30% by mass) of an acrylate copolymer (acrylic polymer (B)) prepared by copolymerization of 2-decyltetradecanyl acrylate (DTDA) and 2-hydroxyethyl acrylate (HEA) in a ratio by mass of (DTDA/HEA) 99/1, and 5 parts by mass (solids content: 8 parts by mass) of a melamine compound “product name “TF200”, manufactured by Kotobukikakou Co., Ltd., methylated melamine resin, solids concentration: 80% by mass) as the crosslinking agent (C) were dissolved in a mixed solvent (toluene/methyl ethyl ketone=70/30 (ratio by mass)), and then 2 parts by mass of a methanol solution of p-toluenesulfonic acid (containing 50% by mass of p-toluenesulfonic acid) as a catalyst was added thereto and stirred to give a solution of a release agent composition having a solids concentration of 2.5% by mass.

The resultant release agent composition solution was applied to a substrate, PET film (product name “Diafoil T100”, by Mitsubishi Plastics, Inc., thickness: 50 μm) using a Meyer bar so that the dry thickness thereof could be 150 nm, then cured by drying at 150° C. for 60 seconds to form a release agent layer, and aged in an environment at 23° C. and 50% RH for 1 week to produce a release sheet having the substrate and the release agent layer.

### (Production of Pressure Sensitive Adhesive Sheet)

A solution of an acrylic pressure sensitive adhesive agent (product name BPS-5127”, manufactured by Toyo Ink Co., Ltd.) was applied onto the face of the release agent layer of the release sheet using an applicator, and dried at 100° C. for 120 seconds to form a pressure sensitive adhesive layer having a thickness of 25 μm. A PET film having a thickness of 50 μm (product name “Diafoil T100”, by Mitsubishi Plastics, Inc.) was stuck to this to give a pressure sensitive adhesive sheet.

The resultant release sheet and the pressure sensitive adhesive sheet were evaluated according to the above-mentioned evaluation methods. The results are shown in Table 1.

### Example 2

This is the same as Example 1 except that the acrylic polymer (B) was changed to an acrylate copolymer prepared by copolymerization of 2-hexyldecyl acrylate (2HDA) and 2-hydroxyethyl acrylate (HEA) in a ratio by mass (2HDA/HEA) of 99/1, as shown in Table 1.

### Examples 3, 4

These are the same as Example 1 except that the ratio by mass of the rubber elastomer (A), the acrylic polymer (B) and the crosslinking agent (C) (A/B/C) was changed to 90/10/8 or 50/50/8, as shown in Table 1.

### Example 5

This is the same as Example 1 except that the rubber elastomer (A) was changed to a hydroxy group both-terminated liquid hydrogenated polyisoprene (product name “Epol”, manufactured by Idemitsu Kosan Co., Ltd., number average molecular weight (Mn): 4,400).

### Example 6

This is the same as Example 1 except that the acrylic polymer (B) was changed to an acrylate copolymer prepared by copolymerization of 2-decyltetradecanyl acrylate (DTDA) and 2-hydroxyethyl acrylate (HEA) in a ratio by mass (DTDA/HEA) of 95/5, as shown in Table 1.

### Examples 7, 8

These are the same as Example 1 except that the thickness of the release agent layer was changed to 300 nm or 100 nm, as shown in Table 1.

### Comparative Example 1

This is the same as Example 1 except that a polyester resin (product name “Vylon 220”, manufactured by Toyobo Co., Ltd., number-average molecular weight (Mn): 3,000, hydroxyl value: 50 mgKOH/g) was used in place of the hydroxy group both-terminated polybutadiene and that an acrylate copolymer prepared by copolymerization of lauryl acrylate (LA) and 2-hydroxyethyl acrylate (HEA) in a ratio by mass (LA/HEA) of 99/1 was used as the acrylic polymer (B).

### Comparative Example 2

This is the same as Example 1 except that an acrylate copolymer prepared by copolymerization of lauryl acrylate (LA) and 2-hydroxyethyl acrylate (HEA) in a ratio by mass (LA/HEA) of 99/1 was used as the acrylic polymer (B).

### Comparative Example 3

This is the same as Example 1 except that an acrylate copolymer prepared by copolymerization of stearyl acrylate (StA) and 2-hydroxyethyl acrylate (HEA) in a ratio by mass (StA/HEA) of 99/1 was used as the acrylic polymer (B).

TABLE 1

| | | Component (B) | | | | | | Thickness | | | Release | |
|---|---|---|---|---|---|---|---|---|---|---|---|---|
| | | | | Carbon | | | Solid | of | | Si | Agent | |
| | | | Molec- | Number | | | Ratio | Release | Surface | Element | Occu- | Peel |
| | Com- | Copolymerization | ular | of | | Com- | (by | Agent | Free | Ratio | pancy | Force |
| | ponent | Ratio | Weight | Side | Branched | ponent | mass) | Layer | Energy | [Atom | Ratio | [mN/ |
| | (A) | (by mass) | [Mw] | Chain | Structure | (C) | A/B/C | [nm] | [mJ/m²] | %] | [%] | 20 mm] |
| Example 1 | R-45HT | DTDA/HEA = 99/1 | 137,200 | 24 | yes | TF200 | 70/30/8 | 150 | 27.0 | 0.0 | 47.8 | 95 |
| Example 2 | R-45HT | 2HDA/HEA = 99/1 | 163,300 | 16 | yes | TF200 | 70/30/8 | 150 | 23.9 | 0.0 | 15.8 | 120 |
| Example 3 | R-45HT | DTDA/HEA = 99/1 | 137,200 | 24 | yes | TF200 | 90/10/8 | 150 | 27.5 | 0.0 | 25.1 | 120 |
| Example 4 | R-45HT | DTDA/HEA = 99/1 | 137,200 | 24 | yes | TF200 | 50/50/8 | 150 | 27.2 | 0.0 | 45.3 | 100 |
| Example 5 | Epol | DTDA/HEA = 99/1 | 137,200 | 24 | yes | TF200 | 70/30/8 | 150 | 23.6 | 0.0 | 30.5 | 100 |
| Example 6 | R-45HT | DTDA/HEA = 95/5 | 117,300 | 24 | yes | TF200 | 70/30/8 | 150 | 28.2 | 0.0 | 50.4 | 100 |
| Example 7 | R-45HT | DTDA/HEA = 99/1 | 137,200 | 24 | yes | TF200 | 70/30/8 | 300 | 28.8 | 0.0 | 41.9 | 90 |
| Example 8 | R-45HT | DTDA/HEA = 99/1 | 137,200 | 24 | yes | TF200 | 70/30/8 | 100 | 26.1 | 0.0 | 10.4 | 120 |
| Com- | Vylon 220 | LA/HEA = 99/1 | 148,300 | 12 | no | TF200 | 70/30/8 | 150 | 31.7 | 0.0 | 70.1 | 185 |
| parative | | | | | | | | | | | | |
| Example 1 | | | | | | | | | | | | |
| Com- | R-45HT | LA/HEA = 99/1 | 148,300 | 12 | no | TF200 | 70/30/8 | 150 | 26.5 | 0.0 | 58.1 | 205 |
| parative | | | | | | | | | | | | |
| Example 2 | | | | | | | | | | | | |
| Com- | R-45HT | StA/HEA = 99/1 | 181,000 | 18 | no | TF200 | 70/30/8 | 150 | 22.8 | 0.0 | 28.3 | unre- |
| parative | | | | | | | | | | | | leasable |
| Example 3 | | | | | | | | | | | | |

It is known that, in Examples 1 to 8, both the release agent occupancy ratio and the peel force were low, and the release agent composition contained predetermined components (A) and (B), and therefore the release agent components were prevented from transferring and the composition realized easy releasability.

As opposed to these, in Comparative Examples 1 and 2, the acrylic polymer did not have a branched alkyl group having a large carbon number in the side chain, and therefore the release agent compositions could not be sufficiently prevented from transferring and the peel force could not be sufficiently lightened. Further, as in Comparative Example 3, when a linear alkyl group having a relatively large carbon number was introduced into the side chain of the acrylic polymer, the release agent components were prevented from transferring but the composition could not realize sufficient releasability.

1. A release agent composition, comprising:
a rubber elastomer (A) and
an acrylic polymer (B) containing a structural unit derived from a long-chain alkyl (meth)acrylate (b1) represented by formula (1): 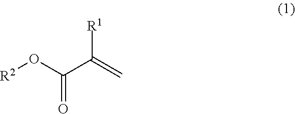
wherein R¹ represents a hydrogen atom or a methyl group, and R² represents a branched alkyl group having 10 to 30 carbon atoms.

2. The release agent composition according to claim 1, wherein the long-chain alkyl (meth)acrylate (b1) is represented by formula (2): 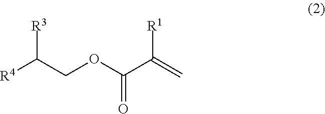
wherein R¹ represents a hydrogen atom or a methyl group, and R³ and R⁴ each independently represent a linear or branched alkyl group having 2 to 20 carbon atoms.

3. The release agent composition according to claim 2, wherein R³ and R⁴ in the formula (2) each are a linear alkyl group.

4. The release agent composition according to claim 1, wherein the acrylic polymer (B) contains the structural unit derived from a long-chain alkyl (meth)acrylate (b1) in a ratio of 80% by mass or more.

5. The release agent composition according to claim 1, wherein the acrylic polymer (B) further contains a structural unit derived from a functional group-containing monomer (b2) containing at least one functional group selected from the group consisting of a hydroxy group, a carboxy group, and an amino group.

6. The release agent composition according to claim 1, wherein the mass-average molecular weight of the acrylic polymer (B) is from 50,000 to 500,000.

7. The release agent composition according to claim 1, wherein the rubber elastomer (A) is at least one selected from the group consisting of a polybutadiene, a polyisoprene, a styrene-butadiene copolymer, a styrene-isoprene copolymer, an acrylonitrile-butadiene copolymer, a polychloroprene, a hydrogenate thereof, an olefinic copolymer, and a polyisobutylene.

8. The release agent composition according to claim 1, wherein the rubber elastomer (A) has at least one functional group selected from the group consisting of a hydroxy group, a carboxy group, an amino group, an isocyanate group and a (meth)acryloyl group.

9. The release agent composition according to claim 1, wherein a number-average molecular weight of the rubber elastomer (A) is from 500 to 30,000.

10. The release agent composition according to claim 1, wherein a mass ratio of the rubber elastomer (A) to the acrylic polymer (B) is within a range of (A)/(B)=1/99 to 99/1.

11. The release agent composition according to claim 1, further comprising:
a crosslinking agent (C).

12. A release sheet, comprising:
a substrate, and,
as provided on at least one face of the substrate, a release agent layer formed of a cured product of the release agent composition of claim 1.

13. The release sheet according to claim 12, wherein a thickness of the release agent layer is from 50 to 1,000 nm.

14. The release sheet according to claim 12, wherein the release agent layer has a surface free energy, as measured according to a contact angle method, of 30 mJ/m² or less.

15. A pressure sensitive adhesive body comprising:
the release sheet of claim 12, and
a pressure sensitive adhesive layer provided on the release agent layer of the release sheet.
